(19) United States
(12) Patent Application Publication
(10) Pub. No.: US 2020/0205422 A1
(43) Pub. Date: Jul. 2, 2020

(54) BULGUR CRUST AND METHOD OF MAKING SAME

(71) Applicant: Hisham A. Elkhatib, Corona, CA (US)

(72) Inventor: Hisham A. Elkhatib, Corona, CA (US)

(21) Appl. No.: 16/732,260

(22) Filed: Dec. 31, 2019

Related U.S. Application Data
(60) Provisional application No. 62/786,808, filed on Dec. 31, 2018.

(51) Int. Cl. A21D 2/36; A21C 9/06; A23L 25/00; A21D 13/02

(52) U.S. Cl. CPC A21D 2/36; A21D 13/02; A23L 25/20; A21C 9/06

(57) ABSTRACT

Fillable crusts including Bulgur wheat and methods for making the same are disclosed. Dough is formed into a pre-determined configuration by molds with surfaces matching the predetermined configuration. The dough is inductively cooked by inductively heating the molds. Additional examples of configurations include a flat disk, a concave disk, and a star shaped cup with multiple points. A filling is formed by mixing and pre-cooking a variety mixture of ingredients including sweet and savory. The filling is located within the fillable crust. The fillable crusts may be packaged and refrigerated for further use or cooked then immediately filled within a typical food preparation procedure.

### CROSS REFERENCE

This application claims the benefit of U.S. Provisional Application No. 62/786,808, filed on Dec. 31, 2018. This application expressly incorporates by reference this provisional patent application.

### FIELD

The field of this disclosure includes fillable crusts made from Bulgur wheat and methods of cooking the same.

### BACKGROUND

Doughs and food products from doughs are typically made from grains (for example, wheat, barley, rye) containing carbohydrates and gluten protein. Wheat has become a staple food product in the modern Western diet. Bulgur is an ancient wheat food of Near Eastern origin, offering whole grain nutrition, high carbohydrate content to supply energy and low fat content. Bulgur is referred to as “Arisah” in the Old Testament and is variously known as Bulgar, Boulgor, Bulgor, Brughoul and Burghoul. Bulgur is the common name given in North America for a hard (durum) cracked wheat which has been steamed, dried, then crushed into a fine, medium or coarse grind. Bulgur is an increasingly popular side dish and offers binding properties similar to potato rice and flour.

Kerkorian U.S. Pat. No. 5,246,721 discloses a method and apparatus for forming a food article. The food article described in Kerkorian is a shell made with finely ground meat that is molded in an apparatus and stuffed with a filler consisting of seasoned coarsely ground meat-with the binder being Bulgur wheat and pine nuts. Alternatively, the binder can include vegetables and rice, or the shell can be filled without any meat. The entire food article described as Kibbe is expressed as savory in taste, made in situ in the apparatus, and is cooked later in its entirety.

Khazaal, U.S. Published patent application 2004/258,806 discloses methods for making Bulgur food articles and products thereof. Khazaal distinguishes itself from Kerkorian by stating that Kerkorian discloses the shell and filling are cooked together but “it is much more desirable to pre-cook the filling and dispense it into the shell.” The food articles comprise an outer shell formed by mixing and grinding a mixture of Bulgur, raw meat, seasonings and an edible fluid. The outer shell is formed into a pre-determined configuration. Examples of configurations include a miniature football, a hamburger, a cookie, a hot dog, a sausage, an egg and a ball. A filling is formed by mixing and pre-cooking a mixture of raw meat, onion, seasonings and nuts. The filling is located within the outer shell. The food articles are packaged and frozen for further use or immediately cooked using edible oil. It is understood from Khazaal's disclosure that his vision was limited to savory food articles and not either savory or sweet food articles.

### SUMMARY

One aspect of the disclosure is fillable crusts including Bulgur wheat.

Another aspect of the disclosure are methods of cooking the same.

Another aspect of the disclosure are the possibilities of making the fillable crusts including bulgur either savory or sweet in taste.

There are several benefits to pre-cooking the crust:

1. Makes it possible to package for retail outlets as a food predation ingredient. and used for cooking in the desired quantity thereafter.

2. Allows the consumer or restaurant to be creative in the art of making own fillings.

3. Significantly reduces the amount of time required to make a healthy hors d'oeuvres containing bulgur.

4. Longer shelf life without filling.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a schematic of a system for cooking a dough including Bulgur wheat according to an embodiment of the present disclosure.

FIG. 2 is a schematic of the system of FIG. 1 pressing the dough of FIG. 1.

FIG. 3 is a schematic of a system of FIG. 1 cooking the dough of FIG. 1 to make a fillable crust including Bulgur wheat.

FIG. 4 is another schematic of a system for cooking a dough including Bulgur wheat according to another embodiment of the present disclosure.

FIG. 5 is a schematic of the system of FIG. 4 pressing the dough of FIG. 1.

FIG. 6 is a schematic of a system of FIG. 4 cooking the dough of FIG. 1 to make a fillable crust including Bulgur wheat.

FIG. 7 is yet another schematic of a system for cooking a dough including Bulgur wheat according to yet another embodiment of the present disclosure.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

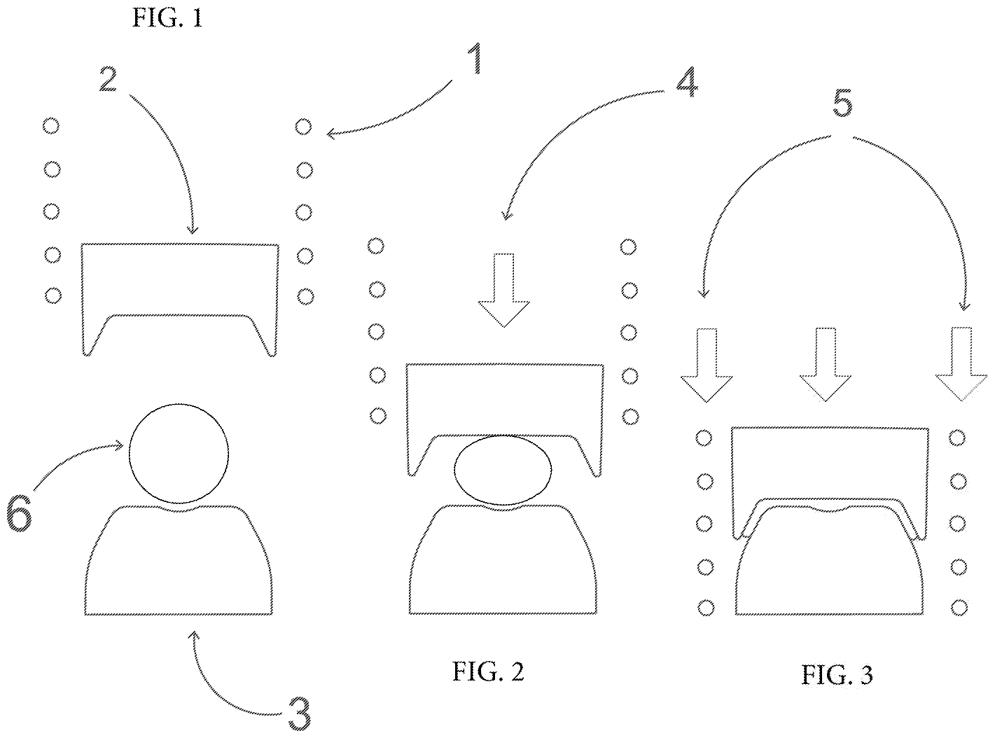

FIG. 1 is a schematic illustrating system 10. A dough including Bulgur wheat 6 in the shape of a ball is provided on an inner cup steel mold 3. Above the dough 6 and the mold 3 is an outer cup steel mold 2 surrounded by an induction heater coil 1. Surface 2.1 of outer cup steel mold 2 is configured to create an outer surface pattern or design on fillable crust 6.1 including Bulgur wheat (FIG. 3). Similarly surface 3.1 of inner cup steel mold 3 is configured to create an inner surface pattern or design on fillable crust 6.1 including Bulgur wheat (FIG. 3). It is also envisioned that surfaces 2.1 and 3.1 may be shaped into various forms so that the fillable crusts 6.1 provide novelty foods or can be used in place of conventional foods. U.S. Published patent application number 2004/0258,806 discloses several shapes including miniature football, a hamburger, a cookie, a hot dog, a sausage, an egg and a ball. While these shapes may be suitable for closed shell food articles, shapes for open fillable Bulgur crusts may include a cup, a star shaped cup with multiple points, a flat disk, and a disk with concave curvature.

FIGS. 2 and 3 illustrate movement of parts to facilitate molding and cooking of dough 6 into fillable crust 6.1 including Bulgur wheat. In FIG. 2 first press motion 4 moves outer cup steel mold 2 toward inner cup steel mold 3. First press motion 4 causes dough 6 to flatten and conform to surfaces 2.1 and 3.1.

In FIG. 3, second press motion 5 places molds 2, 3 within induction coil 1. While second press motion 5 is shown as moving induction coil 1 to align with molds 2, 3, it is also envisioned that molds 2,3 move to align with induction coil 1. Induction heating is utilized to heat electrically conducting molds 2, 3 by electromagnetic induction. Molds 2, 3 are heated to facilitate induction cooking of dough 6 to create fillable crust 6.1 including Bulgur wheat.

The fillable crusts 6.1 may be packaged and refrigerated for further use or immediately used for consumption with or without adding cooked filling. When the fillable crusts 6.1 are packaged and refrigerated for future cooking, the fillable crusts 6.1 may be defrosted prior to warming or cooked directly without being defrosted. When cooked from frozen, the fillable crusts 6.1 is cooked for at least 15 minutes at 350° F. (177° C.). Alternatively, the fillable crusts 6.1 is not frozen and is immediately fully cooked using with filling for at least 5 minutes at 350° F. (177° C.). The fillable crusts 6.1 is brown and glossy in appearance. After fully cooking the fillable crusts 6.1 is ready for consumption.

Dough 6 typically comprises a mixture of fine ground Bulgur wheat (produced by Sunnyland Mills, in Fresno, Calif., U.S.A.), and an edible fluid such as water. More additives such as potatoes, onions, pomegranate molasses, sugar, corn syrup, oil, or flavors may be added to satisfy either savory or sweet variety tastes. Equivalent grades of Bulgur may also be obtained from other sources. The dough is mixed at least once to blend all ingredients. A preferred mixture for Dough 6 typically comprises 1 pound (454 grams) of Bulgur wheat, 0.5 pounds (227 grams) of potatoes, 0.5 pounds (227 grams) of onions, pomegranate molasses to taste, and 1 pound (454 grams) of an edible fluid such as water. It is to be understood that the mixture may be scaled up for larger batches. Other acceptable ranges for Bulgur wheat to vegetable to an edible fluid are from 1:2:1 to 4:1:4 by weight. Typically, the Bulgur wheat absorbs most of the edible fluid. Excess edible fluid is decanted from the mixture. The dough 6 is kept to a consistency that is sufficiently pliable to be able to form a predetermined configuration, which will not collapse because the fillable crusts 6.1 is too dry. The fillable crusts 6.1 is formed into the required configuration leaving a void for a filling.

An uncooked filling may typically comprise a mixture of raw meat, onion, seasoning and nuts. The raw meat may include beef, lamb, pork, poultry, venison rabbit or combinations thereof. Poultry includes turkey, chicken other birds or combinations thereof. Seasonings may include salt, pepper, paprika, others that are used as flavor enhancers in cooking or combinations thereof. In addition, fish or other seafood may be substitutes for meat and other vegetables may also be added. Nuts include pine nuts but may also include peas, beans, chick peas, peanuts, pecans, almonds walnuts or combinations thereof. It is to be understood that other vegetarian or vegan fillings may also be used. A preferred typical mixture for filling comprises 1 pound (454 grams) of meat, (454 grams) of potatoes and onions and 0.5 pound (227 grams) of nuts with seasoning added to taste. It is to be understood that the mixture may be scaled up for larger batches. Other acceptable ranges for meat to onion to nuts are from 4:2:1 to 8:2:1 by weight. The filling mixture may be blended and pre-cooked with a vegetable oil, margarine or butter for at least 5 minutes at 350° F. (177° C.).

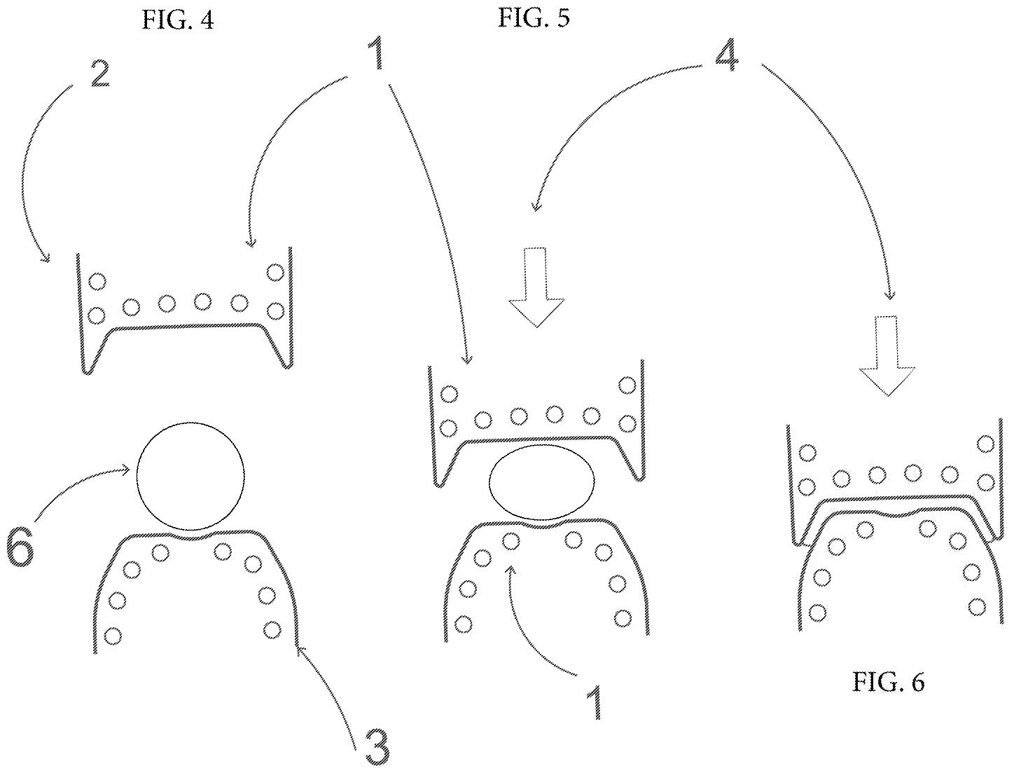

FIGS. 4-6 illustrate an alternative arrangement of induction coils 1.1. In FIGS. 4 and 5 a first press motion 4 moves outer cup steel mold 2 toward inner cup steel mold 3. In FIGS. 4-6, induction coil 1.1 is permanently arranged to align and move simultaneously with molds 2, 3. While there is no second press motion shown in FIGS. 4-6 as separately moving induction coil 1.1 to align with molds 2, 3, it is also envisioned that first press motion 4 moves outer cup steel mold 2 toward inner cup steel mold 3 or vice versa.

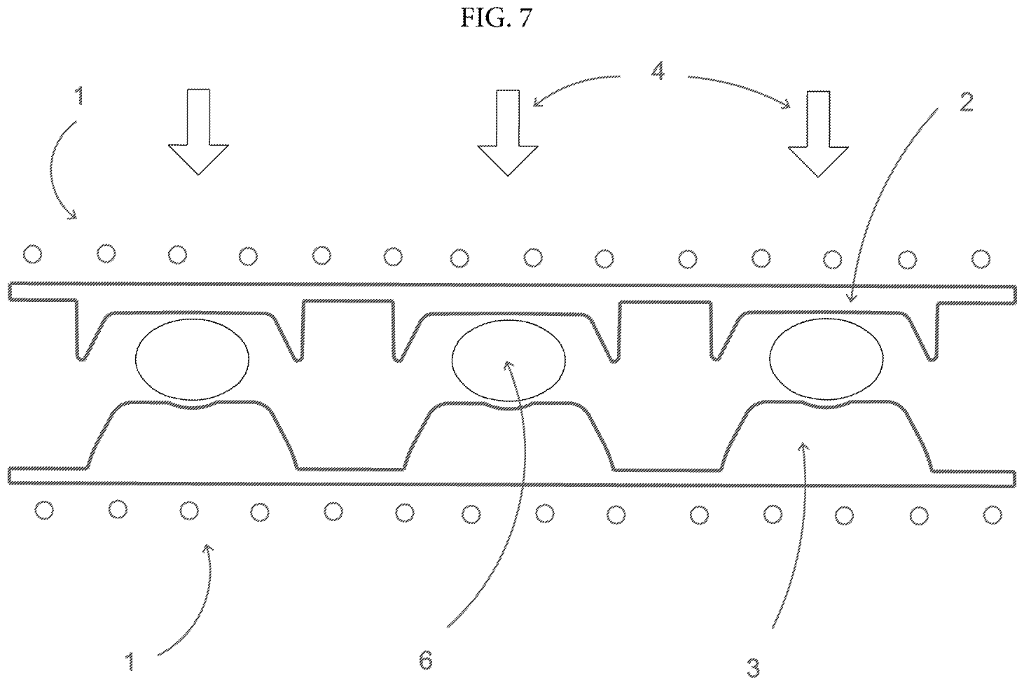

FIG. 7 illustrates yet another alternative arrangement of system 10.1. In FIG. 7, steel plate is shaped to include a plurality of molds 2.1 and 3.1. Induction coil 1.2 is arranged to align and move simultaneously with molds 2.1 and 3.1. It is also envisioned that the plurality of molds can be arranged in a circular, spiral, square, or in straight line patterns.

In summary, fillable crusts including Bulgur wheat and methods for making the same are disclosed. The fillable crusts 6.1 are formed into a pre-determined configuration. Additional examples of configurations include a flat disk, a concave disk, and a star shaped cup with multiple points. Fillable crusts can be either sweet in taste or savory. A filling can be either sweet in taste or savory as well, and is formed by mixing and pre-cooking a variety mixture of ingredients. The filling is located within the fillable crust. The fillable crusts may be packaged and refrigerated for further use or immediately cooked with the filling.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A composition comprising:
bulgur wheat,
a vegetable;
and an edible fluid,
wherein the composition is blended to render a dough with either a savory or a sweet taste, wherein the vegetable is selected from the group consisting of potatoes, onions and combinations thereof,
and wherein the range of ratio for Bulgur wheat to edible fluid are from about 1:1 by weight, wherein the range of ratio for bulgur wheat to vegetable are from about 1:2 to about 4:1 by weight, and wherein the range of ratio for vegetable to edible fluid are from about 2:1 to about 1:4 by weight.

2. The composition of claim 1 further comprising an additive, wherein the additive is selected from the group consisting of pomegranate molasses, sugar, corn syrup, oil, flavors and combinations thereof.

3. The composition of claim 2 wherein the savory taste or the sweet taste is acquired by modifying the ratios of the composition or the additive.

4. The composition of claim 1, wherein the composition comprises 1 pound (454 grams) of Bulgur wheat, 0.5 pounds (227 grams) of potatoes, 0.5 pounds (227 grams) of onions, pomegranate molasses to taste, and 1 pound (454 grams) of an edible fluid.

5. A food product comprising the composition of claim 1 and at least one filling.

6. The food product of claim 5, wherein the filling comprises a mixture of raw meat, onion, seasoning and nuts.

7. The filling of claim 6, wherein the ranges of ratio for meat to onion is from about 4:2 to 8:2 by weight, wherein the ranges of ratio for meat to nuts is from about 4:1 to about 8:1 by weight, and wherein the ranges of ratio for onion to nuts is about 2:1 by weight.

8. The food product of claim 5, wherein the filling mixture comprises 1 pound (454 grams) of meat, (454 grams) of potatoes, and onions or combination thereof, and 0.5 pound (227 grams) of nuts with seasoning added to taste.

9. The filling of claim 6, wherein the raw meat is selected from the group consisting of beef, lamb, pork, poultry, venison, rabbit, fish or other seafood, and combinations thereof.

10. The filling of claim 9, wherein poultry is selected from the group consisting of turkey, chicken, other birds and combinations thereof.

11. The filling of claim 6, wherein the seasoning is selected from the group consisting of salt, pepper, paprika, other flavor enhancers and combinations thereof.

12. The food product of claim 6, wherein nuts are selected from the group consisting of pine nuts, peas, beans, chick peas, peanuts, pecans, almonds, walnuts and combinations thereof.

13. The food product of claim 5, wherein the filling is vegetarian or vegan.

14. A method for making a fillable crust including Bulgur wheat comprising the steps of:
providing an uncooked composition including Bulgur wheat, a vegetable, an edible fluid, and optionally an additive, wherein the composition is blended to render a dough with either a savory or a sweet taste, and wherein the range of ratio for Bulgur wheat to edible fluid are from about 1:1 by weight, wherein the ranges of ratio for bulgur wheat to vegetable are from about 1:2 to about 4:1 by weight, and wherein the ranges of ratio for vegetable to edible fluid are from about 2:1 to about 1:4 by weight;
providing an outer cup steel mold, an inner cup steel mold supporting the dough, and an induction heater coil;
pressing the molds together to conform a shape to the dough by the surfaces of the molds; and
inductively heating the molds to cook the dough to make a fillable crust including Bulgur wheat.

15. The method of claim 15, wherein excess edible fluid is decanted from the composition.

16. The method of claim 15, wherein the dough is kept to a consistency that is sufficiently pliable to be able to form a predetermined configuration, which will not collapse because the fillable crusts is too dry.

17. The method of claim 15, wherein the fillable crust is formed into the required configuration leaving a void for a filling.

18. The method of claim 15, wherein the filling mixture may be blended and pre-cooked with a vegetable oil, margarine or butter for at least 5 minutes at 350° F. (177° C.).
